(19) United States
(12) Patent Application Publication
(10) Pub. No.: US 2016/0217460 A1
(43) Pub. Date: Jul. 28, 2016

(54) Affiliate Server, Affiliate System, Affiliate Method and Program for Affiliate Server

(71) Applicant: OPTiM Corporation, Saga-shi (JP)

(72) Inventor: Shunji SUGAYA, Tokyo (JP)

(21) Appl. No.: 14/727,308

(22) Filed: Jun. 1, 2015

Related U.S. Application Data
(60) Provisional application No. 62/128,120, filed on Mar. 4, 2015.

(30) Foreign Application Priority Data
Jan. 22, 2015 (JP) 2015-10750

(51) Int. Cl. G06Q 20/38

(52) U.S. Cl. CPC G06Q 20/38

(57) ABSTRACT

The present invention provides an affiliate server, an affiliate system, an affiliate method, and a program for the affiliate server, by using brick-and-mortar stores. The affiliate server associates and stores an application ID associated with an application running in a content user terminal 10 with facility information associated with a facility in which the application is executed, identifies the facility by comparing the received application ID with the facility information associated with the application ID when receiving the payment permission data permitting payment of the application and the application ID of the application, the payment of the application being permitted, and executes a payment process to the identified facility.

### CROSS REFERENCE TO RELATED APPLICATIONS

This application claims priority to Japanese Pat. App. No. 2015-10750, filed Jan. 22, 2015, and U.S. Provisional Pat. App. No. 62/128,120, filed Mar. 4, 2015, the contents of each application are incorporated herein by reference.

### TECHNICAL FIELD

The present invention relates to an affiliate server, an affiliate system, an affiliate method, and a program for the affiliate server.

### BACKGROUND ART

Recently, there has been affiliate advertising as a form of advertising on the Internet. In such affiliate advertising, an internet site owner adds links for commodities and services to their web pages, e-mail magazines, etc. When users purchase the targeted commodities and services through these links, the advertisers pay commission to the internet site owner.

Moreover, various services have been provided to users by connecting mobile terminals connected with a public network to web servers, etc. in recent years. In particular, the appearance of smart phones (high functional mobile phones) can provide mobile phones with advanced services provided to personal computers. For example, users can execute applications and read electronic books with a mobile terminal.

Users can also purchase the targeted commodities and services with a mobile terminal through the affiliate links that Internet site owners added.

Such affiliate advertising brings many advantages to on-line shopping, etc. but few in brick-and-mortar stores.

To solve this problem, for example, Patent Document 1 discloses that advertisers issue a coupon that is valid at a real store to the users who looked at their advertisement and pay commission to internet site owners based on the purchase information and the coupon that has been presented at checkout.

### CITATION LIST

### Patent Literature

Patent Document 1: JP 2014-106633A

### SUMMARY OF INVENTION

However, presenting the issued coupon at checkout as Patent Document 1 is little beneficial but much troublesome for users.

The present inventor paid attention to affiliate advertising, using brick-and-mortar stores.

To solve the above-mentioned problem, the objective of the present invention is to provide an affiliate server, an affiliate system, an affiliate method, and a program for the affiliate server, by using brick-and-mortar stores.

According to the first aspect of the present invention, an affiliate server includes:

a facility information storage unit associating and storing an application ID associated with an application running in a content user terminal with facility information associated with a facility in which the application is executed;

a facility identifying unit identifying the facility by comparing the received application ID with the facility information associated with the application ID when receiving the payment permission data permitting payment of the application and the application ID of the application, the payment of the application being permitted; and

a payment execution unit executing a payment process to the identified facility.

According to the first aspect of the present invention, the affiliate server associates and stores an application ID associated with an application running in a content user terminal with facility information associated with a facility in which the application is executed, identifies the facility by comparing the received application ID with the facility information associated with the application ID when receiving the payment permission data permitting payment of the application and the application ID of the application, the payment of the application being permitted, and executes a payment process to the identified facility.

The category of the first aspect of the present invention is an affiliate server. However, even if belonging to different categories, the affiliate system, the affiliate method, and the program for the affiliate server have the same working-effect as the affiliate server.

According to the second aspect of the present invention, the affiliate server according to the first aspect of the present invention further includes: a start permission transmitter unit transmitting an instruction to permit the application to start in the content user terminal if the content user terminal exists inside the identified facility, after comparing facility information on the identified facility with terminal information acquired from the content user terminal.

According to the second aspect of the present invention, the affiliate server according to the first aspect of the present invention transmits an instruction to permit the application to start in the content user terminal if the content user terminal exists inside the identified facility, after comparing facility information on the identified facility with terminal information acquired from the content user terminal.

According to the third aspect of the present invention, the affiliate server according to the first or the second aspect of the present invention further includes:

a running times setting unit setting the running times of an application associated with the application ID; and

a stop-at-running times instruction transmitter unit transmitting an instruction to stop the application from running in the content user terminal if the running times of the application in the content user terminal exceeds the set running times.

According to the third aspect of the present invention, the affiliate server according to the first or the second aspect of the present invention sets the running times of an application associated with the application ID; and transmits an instruction to stop the application from running in the content user terminal if the running times of the application in the content user terminal exceeds the set running times.

According to the fourth aspect of the present invention, the affiliate server according to any one of the first to the third aspects of the present invention further includes:

a running period setting unit setting the running period of an application associated with the application ID; and

a stop-at-running period instruction transmitter unit transmitting an instruction to stop the application from running in the content user terminal if the running period of the application in the content user terminal exceeds the set running period.

According to the fourth aspect of the present invention, the affiliate server according to any one of the first to the third aspects of the present invention sets the running period of an application associated with the application ID; and transmits an instruction to stop the application from running in the content user terminal if the running period of the application in the content user terminal exceeds the set running period.

According to the fifth aspect of the present invention, an affiliate system includes: a content user terminal; and an affiliate server, the content user terminal being communicatively connected with the affiliate server, wherein

the content user terminal includes:
an application receiver unit receiving an application from the affiliate server;
an application execution unit executing the received application;
a payment permission transmitter unit transmitting payment permission data permitting payment of the application to the affiliate server; and
an application ID transmitter unit transmitting the application ID of the application, the payment of the application being permitted,

the affiliate server includes:
a facility information storage unit associating and storing an application ID associated with an application running in the content user terminal with facility information associated with a facility in which the application is executed;
a facility identifying unit identifying the facility by comparing the received application ID with the facility information associated with the application ID when receiving the payment permission data and the application ID of the application, the payment of the application being permitted; and
a payment execution unit executing a payment process to the identified facility.

According to the sixth aspect of the present invention, an affiliate method includes the steps of:

associating and storing an application ID associated with an application running in a content user terminal with facility information associated with a facility in which the application is executed;

identifying the facility by comparing the received application ID with the facility information associated with the application ID when receiving the payment permission data permitting payment of the application and the application ID of the application, the payment of the application being permitted, and

executing a payment process to the identified facility.

According to the seventh aspect of the present invention, a program product for use in an affiliate server includes a non-transitory computer usable medium having a set of instructions physically embodied therein, the set of instructions including computer readable code, which when executed by the affiliate server causes the information processing unit to:

associate and store an application ID associated with an application running in a content user terminal with facility information associated with a facility in which the application is executed;

identify the facility by comparing the received application ID with the facility information associated with the application ID when receiving the payment permission data permitting payment of the application and the application ID of the application, the payment of the application being permitted; and

execute a payment process to the identified facility.

The present invention can provide an affiliate server, an affiliate system, an affiliate method, and a program for the affiliate server, by using brick-and-mortar stores.

### BRIEF DESCRIPTION OF DRAWINGS

FIG. 1 shows the configuration view of the affiliate system 1.

FIG. 2 shows the functional block diagrams of the affiliate server 100 and the content user terminal 10.

FIG. 3 shows the flow chart illustrating the processing of the affiliate system 1.

FIG. 4 shows the facility information table.

FIG. 5 shows the diagram illustrating the screen displayed on the content user terminal 10.

FIG. 6 shows the diagram illustrating the screen displayed on the content user terminal 10.

FIG. 7 shows the diagram illustrating the screen displayed on the content user terminal 10.

FIG. 8 shows the diagram illustrating the screen displayed on the content user terminal 10.

### DESCRIPTION OF EMBODIMENTS

Embodiments of the present invention will be described with reference to the attached drawings below. However, these embodiments are illustrative only. The technological scope of the present invention is not limited to these embodiments.

### Configuration of Affiliate System

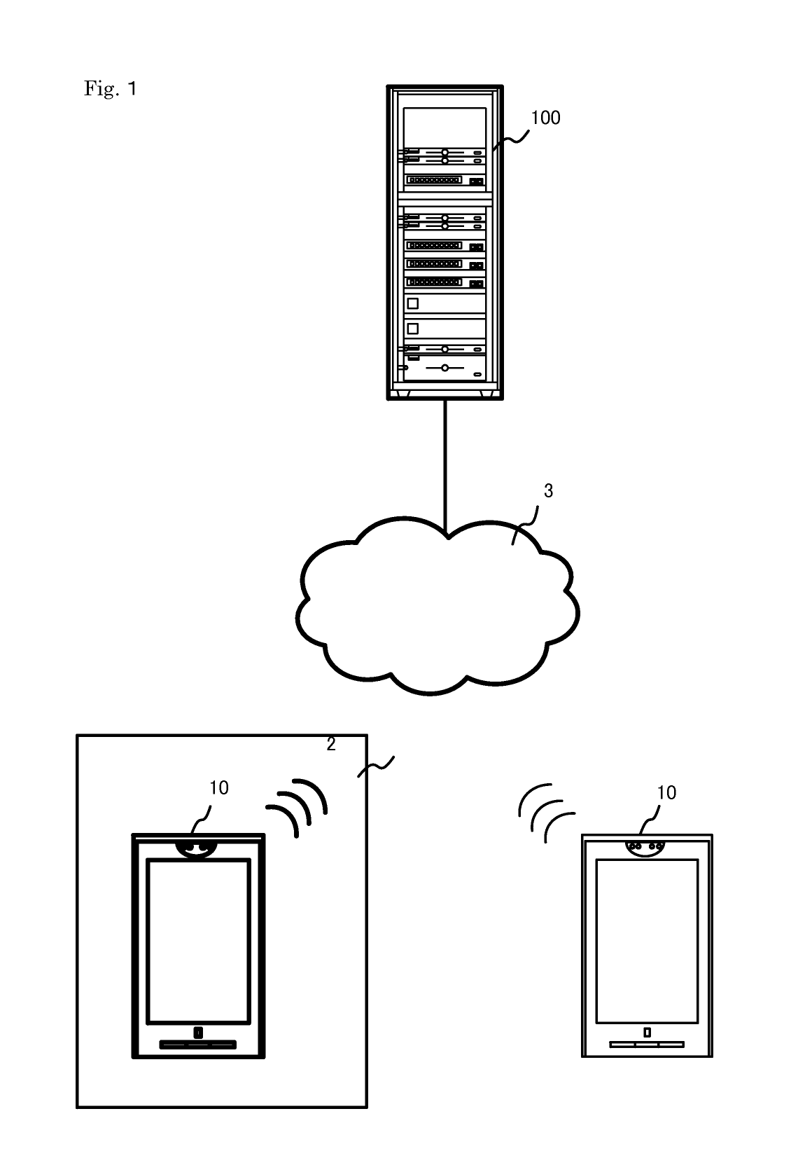

FIG. 1 shows the configuration diagram of the affiliate system 1 as a preferable embodiment of the present invention. The affiliate system 1 is composed of a content user terminal 10, an affiliate server 100, and a public network 3 (the Internet network, the third and the fourth generation communication networks, etc.).

The content user terminal 10 can be communicatively connected with the affiliate server 100 through a public network 3. The content user terminal 10 can be communicated with a beacon terminal provided in a facility 2 through BLE (Bluetooth® Low Energy). The affiliate server 100 and the content user terminal 10 may be connected with a local area network. The affiliate system 1 may be formed through wireless or wired connection or both. The content user terminal 10 may be connected with the public network 3 through networking equipment including a router. The content user terminal 10 may be connected with the beacon terminal by another communication method.

The content user terminal 10 may be a general information terminal such as an information device or an electrical appliance that has the function to be described later. The content user terminal 10 is a general information appliance such as a mobile phone, a smart phone, a computer, a netbook terminal, a slate terminal, an electronic book terminal, an electronic dictionary terminal, a portable music player, or a portable content recording and reproducing device.

The affiliate server 100 manages the application to be described later and performs various processing tasks. The affiliate server 100 is connected with only one content user terminal 10 in this embodiment but may be connected with more than one.

### Functions

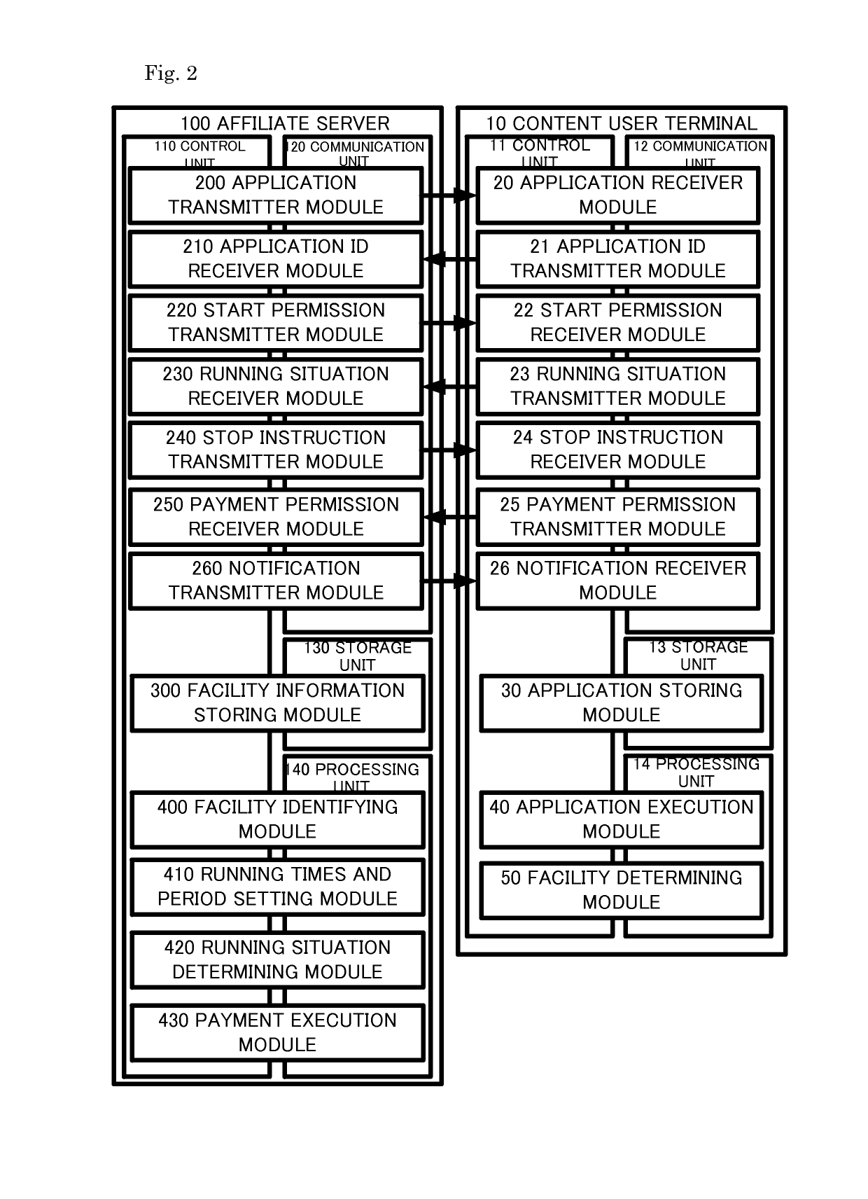

FIG. 2 shows the functional block diagram of the content user terminal 10 and the affiliate server 100 to show the relationship among their functions.

The content user terminal 10 is provided with a control unit 11 including CPU (Central Processing Unit), RAM (Random Access Memory), and ROM (Read Only Memory) and a communication unit 12 including a wireless device supporting the IEEE802.11 standard as WiFi® (Wireless Fidelity) or the IMT-2000 standard for the third generation mobile communication system and optionally a wired device for LAN. The communication unit 12 also includes a Bluetooth® device communicated with a beacon terminal through Bluetooth® communication.

The content user terminal 10 is also provided with an input-output unit including a display outputting and displaying data and images controlled by the control unit 11 and a touch panel, a keyboard, and a mouse, etc. that receive input from a user. The content user terminal 10 is also provided with a storage unit 13 including a hard disk and a semiconductor memory that store data.

In the content user terminal 10, the control unit 11 reads a predetermined program and cooperates with the communication unit 12, the input-output unit, the storage unit 13, and the processing unit 14 to run the application receiver module 20, the application ID transmitter module 21, the start permission receiver module 22, the running situation transmitter module 23, the stop instruction receiver module 24, the payment permission transmitter module 25, the notification receiver module 26, the application storing module 30, the application execution module 40, and the facility determining module 50.

The affiliate server 100 is provided with a control unit 110 including CPU, RAM, and ROM and a communication unit 120 including a wireless device supporting the IEEE802.11 standard as WiFi® and optionally a wired device. The affiliate server 100 is also provided with a storage unit 130 including a hard disk and a semiconductor memory that store data. The affiliate server 100 stores the facility information table in the storage unit 130. The facility information table associates the application IDs to be described later with the SSIDs (Service Set Identifiers) set for WiFi® connection and the beacon ID of the beacon terminal provided in the facility.

In the affiliate server 100, the control unit 110 reads a predetermined program and cooperates with the communication unit 120, the storage unit 130, and the processing unit 140 to run the application transmitter module 200, the application ID receiver module 210, the start permission transmitter module 220, the running situation receiver module 230, the stop instruction transmitter module 240, the payment permission receiver module 250, the notification transmitter module 260, the facility information storing module 300, the facility identifying module 400, the running times and period setting module 410, the running situation determining module 420, and the payment execution module 430.

### Affiliate Processing

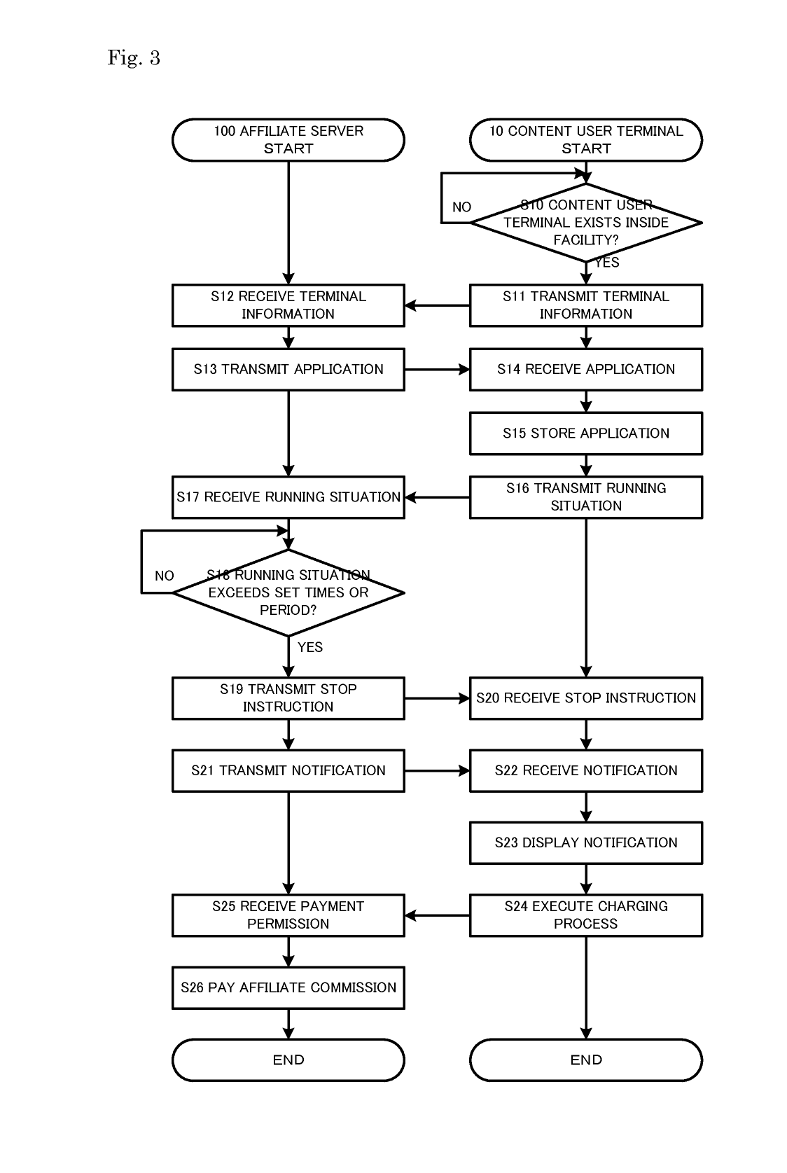

FIG. 3 is the flow chart illustrating the affiliate processing performed by the content user terminal 10 and the affiliate server 100. The processes performed by the modules of each of the above-mentioned devices for the affiliate processing will be described below. The term “affiliate” means herein that an advertiser provides an application to users in the facility, etc. and pays commission to the operator of the facility, etc. at a constant rate if users perform a charging process for this application. The terms “commission” and “charging” are used for the payment in this embodiment. However, not only the payment is made in cash, but also services are provided, the use of articles and lands is permitted, and rights are transferred. The term “facility” means a shop, a complex facility, or a communal facility, for example, a restaurant, a cafe, a shopping mall, an airport, or a station in this embodiment. Needless to say, the facility is not limited to these examples.

The facility determining module 50 of the content user terminal 10 determines whether or not the content user terminal 10 exists inside the facility (S10). The content user terminal 10 may not make this determination but the affiliate server 100 may.

In S10, the content user terminal 10, for example, determines whether or not the content user terminal 10 has acquired the SSID of the facility to connect with the Internet through the WiFi® spot provided in the facility or whether or not the content user terminal 10 has received the beacon ID from the beacon terminal provided in the facility, so as to determine whether or not the content user terminal 10 itself exists inside the facility. The storage unit 130 of the affiliate server 100 associates and stores each facility with an SSID. The storage unit 130 of the affiliate server 100 also associates and stores each facility with a beacon ID.

In S10, if determining that the content user terminal 10 is not being connected with the Internet through the WiFi® spot provided in the facility or that the content user terminal 10 has not received the beacon ID from the beacon terminal provided in the facility (NO), the facility determining module 50 of the content user terminal 10 determines that the content user terminal 10 itself does not exist inside but outside the facility. Then, the facility determining module 50 repeats this determination until the content user terminal 10 has moved in the facility.

In S10, if determining that the content user terminal 10 is being connected with the Internet through the WiFi® spot provided in the facility or that the content user terminal 10 has received the beacon ID from the beacon terminal provided in the facility (YES), the facility determining module 50 of the content user terminal 10 determines that the content user terminal 10 itself exists inside the facility.

Then, the content user terminal 10 transmits the terminal information uniquely identifying the model information, etc. of itself to the affiliate server 100 (S11).

The affiliate server 100 receives the terminal information from the content user terminal 10 (S12).

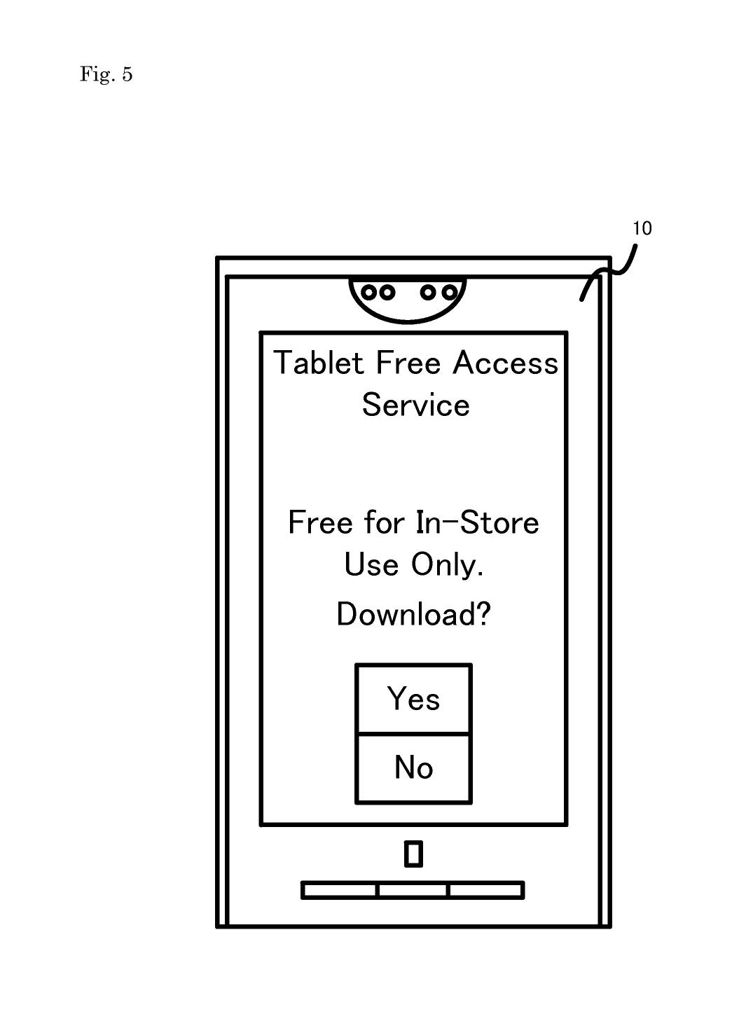

The content user terminal 10 of the user who has moved in the facility displays the screen shown in FIG. 5. This screen may be called by the user from the notification displayed in the content user terminal 10 or may be automatically displayed when the content user terminal 10 determines that the content user terminal 10 itself has moved in the facility. The user acquires an application from the affiliate server 100 by selecting “Yes” displayed in the content user terminal 10.

The application transmitter module 200 of the affiliate server 100 transmits an application to the content user terminal 10 based on the received terminal information (S13).

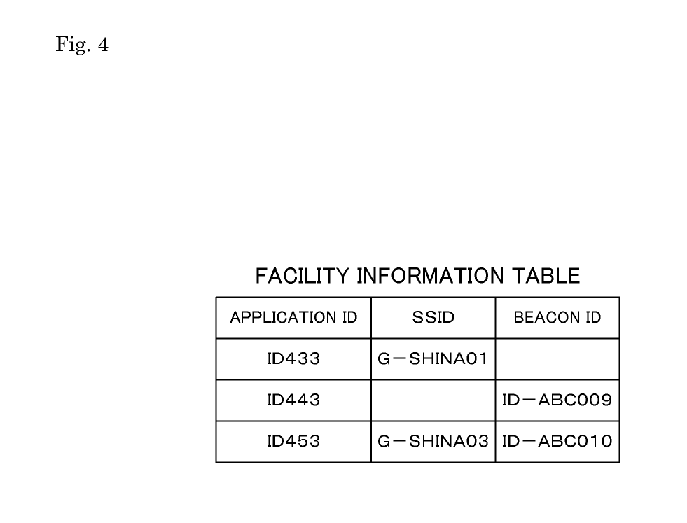

The facility information storing module 300 of the affiliate server 100 associates and stores the application ID of the application transmitted from the application transmitter module 200 of the affiliate server 100 with the SSID of the facility and with the beacon ID of the beacon terminal provided in the facility. The facility is managed by the affiliate server 100. FIG. 4 shows the facility information table that the affiliate server 100 stores. As shown in FIG. 4, the facility information storing module 300 of the affiliate server 100 associates and stores the application running in the content user terminal 10 with an application ID. Moreover, as shown in FIG. 4, the facility information storing module 300 of the affiliate server 100 associates and stores the SSID of the facility with the facility in which the application transmitted to the content user terminal 10 is executed in the content user terminal 10. Still moreover, as shown in FIG. 4, the facility information storing module 300 of the affiliate server 100 associates and stores the beacon ID of the beacon terminal provided in the facility with the facility in which the application transmitted to the content user terminal 10 is executed in the content user terminal 10. The facility information storing module 300 of the affiliate server 100 also associates and stores each of the application IDs with an SSID and a beacon ID.

The application receiver module 20 of the content user terminal 10 receives an application from the application transmitter module 200 of the affiliate server 100 (S14). The application storing module 30 of the content user terminal 10 stores the received application (S15).

The application running module 40 of the content user terminal 10 stores the received application based on, for example, input from a user.

The running situation transmitter module 23 of the content user terminal 10 transmits the running situation of the user's application to the affiliate server 100 (S16). In S16, the running situation transmitted from the running situation transmitter module 23 of the content user terminal 10 is the running times and the running period of the application. The running times shows how many times the application has started in the content user terminal 10. The running period show how long the application is running in the content user terminal 10. The running situation transmitted from the running situation transmitter module 23 of the content user terminal 10 may include other contents.

The running situation receiver module 230 of the affiliate server 100 receives the running situation from the running situation transmitter module 23 of the content user terminal 10 (S17).

The affiliate server 100 determines whether or not to grant the start permission of the application based on the received running situation (S18).

The running times and period setting module 410 of the affiliate server 100 previously provides the running times or the running period of the application to be transmitted to the content user terminal 10. For example, the running times and period setting module 410 of the affiliate server 100 sets the running times to allow each of the applications to run only once.

The running times and period setting module 410 of the affiliate server 100 previously provides the running period of the application to be transmitted to the content user terminal 10. For example, the running times and period setting module 410 of the affiliate server 100 sets the running period to allow each of the applications to run for only 30 minutes.

For example, the running times and period setting module 410 of the affiliate server 100 may set the running times to allow each of the applications to run more than once. For example, the running times and period setting module 410 of the affiliate server 100 may set the running period to allow each of the applications to run for less or more than 30 minutes. For example, the running times and period setting module 410 of the affiliate server 100 may set the running times and the running period to allow each of the applications to run the set times for the set period.

In S18, the running situation determining module 420 of the affiliate server 100 compares the running situation of the received application with the running times or the running period set by the running times and period setting module 410 to determine whether or not the running situation exceeds the set times or period.

In S18, if the running situation determining module 420 of the affiliate server 100 determines that the running situation of the application in the content user terminal 10 does not exceed the set times or period (NO), the start permission transmitter module 220 of the affiliate server 100 transmits the start permission to the content user terminal 10 and repeats this determination.

The start permission receiver module 22 of the content user terminal 10 receives the start permission from the running permission transmitter module 220 of the affiliate server 100. The application execution module 40 of the content user terminal 10 executes the application only when the start permission receiver module has received the start permission of the application.

In S18, if the running situation determining module 420 of the affiliate server 100 determines that the running situation of the application in the content user terminal 10 exceeds the set times or period (YES), the stop instruction transmitter module 240 of the affiliate server 100 transmits the stop instruction to the content user terminal 10.

The stop instruction receiver module 24 of the content user terminal 10 receives the stop instruction from the stop instruction transmitter module 240 of the affiliate server 100 (S20). When the stop instruction receiver module 24 of the content user terminal 10 receives this stop instruction, the content user terminal 10 stops the application executed by the application execution module 40 of the content user terminal 10.

The notification transmitter module 260 of the affiliate server 100 transmits a notification showing that the application is running more than the set times or period to the content user terminal 10 (S21).

The notification receiver module 26 of the content user terminal 10 receives the notification from the notification transmitter module 260 of the affiliate server 100 (S22). The content user terminal 10 displays the received notification on its display (S23).

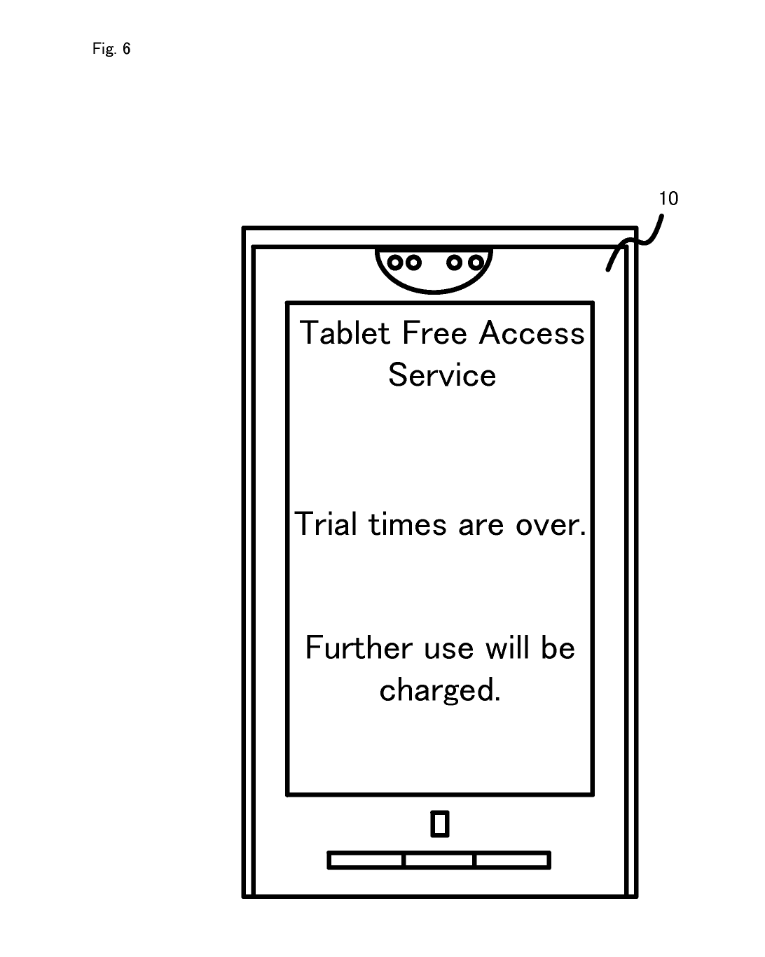

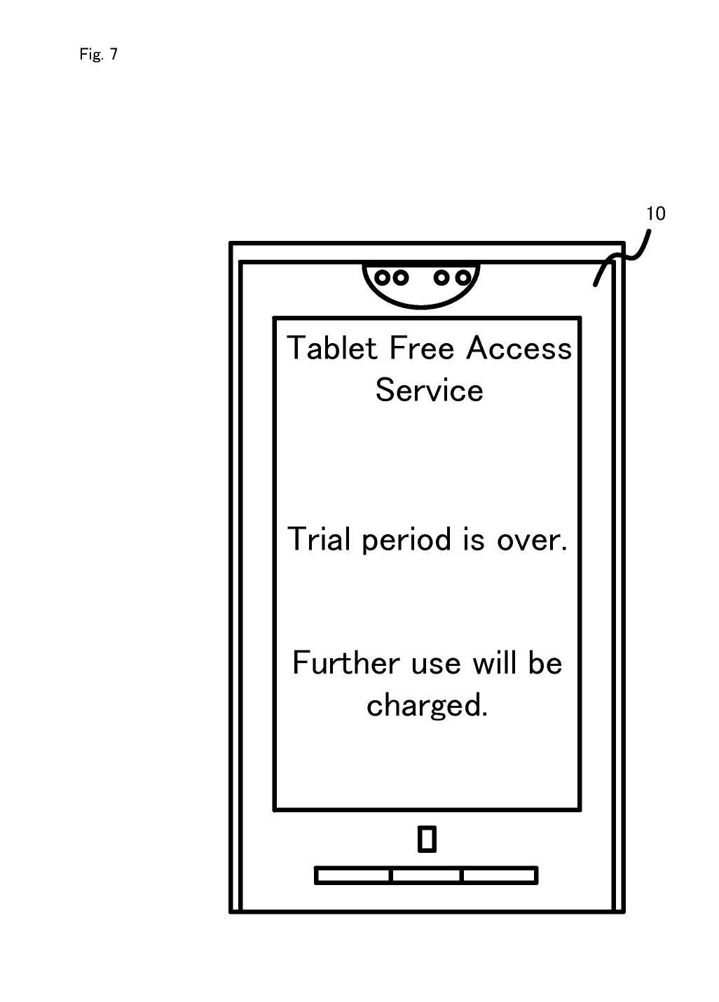

In S23, if the running times of the application reach the times set by the running times and period setting module 410 of the affiliate server 100, the content user terminal 10 displays the notification on its display as shown in FIG. 6. In S23, if the running period of the application reaches the period set by the running times and period setting module 410 of the affiliate server 100, the content user terminal 10 displays the notification on its display as shown in FIG. 7.

As a result, the user can temporarily use the application in the facility. When the user moves out of the facility or when the user persistently uses the application in the facility, a charging process is executed (S24). The charging process is executed by the user's input from the content user terminal 10 to pay the charge of the application.

The running situation determining module 420 of the affiliate server 100 determines whether or not the content user terminal 10 exists inside the facility. If the content user terminal 10 exists inside the facility, the running permission transmitter module 220 of the affiliate server 100 transmits the start permission to the content user terminal 10. At this time, the running situation determining module 420 of the affiliate server 100 receives the information that the content user terminal 10 is being connected with the Internet through the WiFi® spot provided in the facility or that the content user terminal 10 has received the beacon ID from the beacon terminal provided in the facility, so as to determine whether or not the content user terminal 10 exists inside the facility. The affiliate server 100 may determine whether or not the content user terminal 10 exists in the facility by another method. For example, the affiliate server 100 may acquire the current position of the content user terminal 10 by GPS (Global Positioning System) and then may determine whether or not the content user terminal 10 exists inside the facility, based on the acquired current position of the content user terminal 10 and the previously acquired position information of the facility.

If the running situation determining module 420 of the affiliate server 100 determines that the content user terminal 10 does not exist inside the facility, the stop instruction transmitter module 240 transmits the stop instruction to the content user terminal 10 regardless of the running times or the running period set by the running times and period setting module 410 so as to stop the application. If the running situation determining module 420 of the affiliate server 100 determines that the content user terminal 10 exists inside the facility, the start permission transmitter module 220 transmits the start permission to the content user terminal 10 so as to start the application. As a result, the content user terminal 10 can use the application only in the facility.

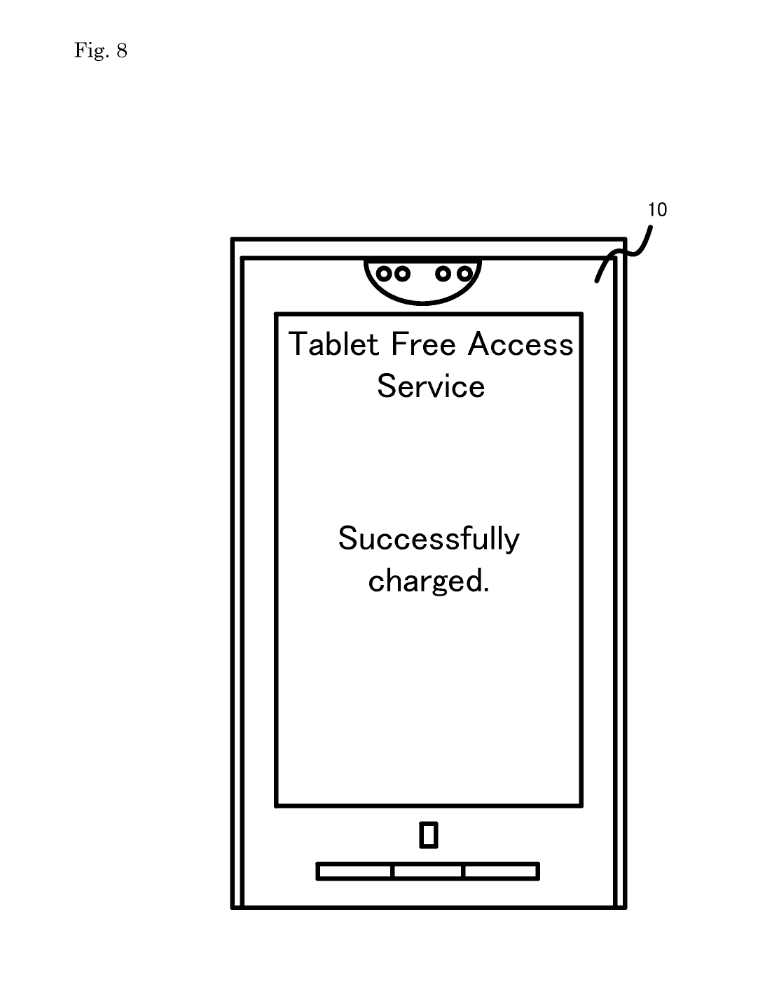

The payment permission transmitter module 25 of the content user terminal 10 transmits the charging process executed by the user's input from the content user terminal 10 to the affiliate server 100. The content user terminal 10 displays the notification showing that the charging process has been completed on its display as shown in FIG. 8. The application ID transmitter module 21 of the content user terminal 10 transmits the application ID of the application for which the user has executed the charging process to the affiliate terminal 100.

The payment permission receiver module 250 of the affiliate server 100 receives the payment permission from the payment permission transmitter module 25 of the content user terminal 10 (S25). The application ID receiver module 210 of the affiliate server 100 receives the application ID from the application ID transmitter module 21 of the content user terminal 10.

When informed that the charging process has been completed, the affiliate server 100 identifies the facility associated with the application ID of the application for which the received payment permission is provided. The facility identifying module 400 of the affiliate server 100 identifies the facility associated with the received application ID based on this application ID and the SSID or the beacon ID that is stored in the facility information table.

Specifically, as the facility information table of FIG. 4 shows, SSID associated with this application ID is “G-SHINA01,” and no beacon ID is associated, when the application ID for which a user has executed the charging process is “ID433.” Then, the facility identifying module 400 of the affiliate server 100 identifies the facility associated with “G-SHINA01” as the facility in which the user has acquired an application with the application ID “ID433.” When the application ID for which a user has executed the charging process is “ID443,” no SSID is associated with this application ID, and the beacon ID is “ID-ABC009.” Then, the facility identifying module 400 of the affiliate server 100 identifies the facility associated with “ID-ABC009” as the facility in which the user has acquired an application with the application ID “ID443.” When the application ID for which a user has input the charging process is “ID453,” the SSID associated with this application ID is “G-SHINA03,” and the beacon ID is “ID-ABC010.” Then, the facility identifying module 400 of the affiliate server 100 identifies the facility associated with “G-SHINA03” and “ID-ABC010” as the facility in which the user has acquired an application with the application ID “ID453.”

The payment execution module 430 of the affiliate server 100 executes the process to pay affiliate commission for the operator of the facility identified by the facility identifying module 400 of the affiliate server 100 (S26). The affiliate commission may be paid to anyone but the facility operator.

To achieve the means and the function that are described above, a computer (including CPU, an information processor, and various terminals) reads and executes a predetermined program. For example, the program is provided in the form recorded in a computer-readable medium such as a flexible disk, CD (CD-ROM, etc.), and DVD (DVD-ROM, DVD-RAM, etc.). In this case, a computer reads a program from the recording medium, forwards and stores the program to and in an internal or an external storage, and executes it. The program may be previously recorded in, for example, a storage (recording medium) such as a magnetic disk, an optical disk, and a magneto-optical disk and provided from the storage to a computer through a communication line.

The embodiment of the present invention is described above. However, the present invention is not limited to the above-mentioned embodiment. The effect described in the embodiment of the present invention is only the most preferable effect produced from the present invention. The effect of the present invention is not limited to those described in the embodiment of the present invention.

### REFERENCE SIGNS LIST

1 affiliate system
3 public network
10 content user terminal
100 affiliate server

1.) An affiliate server comprising:
a facility information storage unit associating and storing an application ID associated with an application running in a content user terminal with facility information associated with a facility in which the application is executed;
a facility identifying unit identifying the facility by comparing the received application ID with the facility information associated with the application ID when receiving the payment permission data permitting payment of the application and the application ID of the application, the payment of the application being permitted; and
a payment execution unit executing a payment process to the identified facility.

2.) The affiliate server according to claim 1, further comprising a start permission transmitter unit transmitting an instruction to permit the application to start in the content user terminal if the content user terminal exists inside the identified facility, after comparing facility information on the identified facility with terminal information acquired from the content user terminal.

3.) The affiliate server according to claim 1, further comprising:
a running times setting unit setting the running times of an application associated with the application ID; and
a stop-at-running times instruction transmitter unit transmitting an instruction to stop the application from running in the content user terminal if the running times of the application in the content user terminal exceeds the set running times.

4.) The affiliate server according to claim 2, further comprising:
a running times setting unit setting the running times of an application associated with the application ID; and
a stop-at-running times instruction transmitter unit transmitting an instruction to stop the application from running in the content user terminal if the running times of the application in the content user terminal exceeds the set running times.

5.) The affiliate server according to claim 1, further comprising:
a running period setting unit setting the running period of an application associated with the application ID; and
a stop-at-running period instruction transmitter unit transmitting an instruction to stop the application from running in the content user terminal if the running period of the application in the content user terminal exceeds the set running period.

6.) The affiliate server according to claim 2, further comprising:
a running period setting unit setting the running period of an application associated with the application ID; and
a stop-at-running period instruction transmitter unit transmitting an instruction to stop the application from running in the content user terminal if the running period of the application in the content user terminal exceeds the set running period.

7.) The affiliate server according to claim 3, further comprising:
a running period setting unit setting the running period of an application associated with the application ID; and
a stop-at-running period instruction transmitter unit transmitting an instruction to stop the application from running in the content user terminal if the running period of the application in the content user terminal exceeds the set running period.

8.) An affiliate system comprising:
a content user terminal; and an affiliate server, the content user terminal being communicatively connected with the affiliate server, wherein
the content user terminal includes:
an application receiver unit receiving an application from the affiliate server;
an application execution unit executing the received application;
a payment permission transmitter unit transmitting payment permission data permitting payment of the application to the affiliate server; and
an application ID transmitter unit transmitting the application ID of the application, the payment of the application being permitted;
the affiliate server includes:
a facility information storage unit associating and storing an application ID associated with an application running in the content user terminal with facility information associated with a facility in which the application is executed;
a facility identifying unit identifying the facility by comparing the received application ID with the facility information associated with the application ID when receiving the payment permission data and the application ID of the application, the payment of the application being permitted; and
a payment execution unit executing a payment process to the identified facility.

9.) An affiliate method comprising the steps of:
associating and storing an application ID associated with an application running in a content user terminal with facility information associated with a facility in which the application is executed;
identifying the facility by comparing the received application ID with the facility information associated with the application ID when receiving the payment permission data permitting payment of the application and the application ID of the application, the payment of the application being permitted; and
executing a payment process to the identified facility.

10.) A program product for use in an affiliate server comprising a non-transitory computer usable medium having a set of instructions physically embodied therein, the set of instructions including computer readable code, which when executed by the affiliate server causes the information processing unit to:
associate and store an application ID associated with an application running in a content user terminal with facility information associated with a facility in which the application is executed;
identify the facility by comparing the received application ID with the facility information associated with the application ID when receiving the payment permission data permitting payment of the application and the application ID of the application, the payment of the application being permitted; and
execute a payment process to the identified facility.
